(19) United States
(12) Patent Application Publication
(10) Pub. No.: US 2019/0147863 A1
(43) Pub. Date: May 16, 2019

(54) METHOD AND APPARATUS FOR PLAYING MULTIMEDIA

(71) Applicant: BAIDU ONLINE NETWORK TECHNOLOGY (BEIJING) CO., LTD., Beijing (CN)

(72) Inventors: Guang LU, Beijing (CN); Shiquan YE, Beijing (CN); Xiajun LUO, Beijing (CN); Xiangjie YIN, Beijing (CN)

(21) Appl. No.: 15/858,538

(22) Filed: Dec. 29, 2017

(30) Foreign Application Priority Data
Nov. 14, 2017 (CN) 201711119577.4

(51) Int. Cl. G10L 15/22; G10L 15/02; G06F 17/30

(52) U.S. Cl. CPC G10L 15/22; G10L 15/02; G10L 2015/225; G10L 2015/223; G06F 17/30056

(57) ABSTRACT

Embodiments of the present disclosure disclose methods and apparatuses for playing multimedia. A specific implementation of the methods includes: receiving a voice play request inputted by a user; extracting a scheduled play timing and a play parameter from the voice play request; generating a multimedia list based on the play parameter; and playing multimedia in the multimedia list, in response to a current timing meeting the scheduled play timing. The embodiment improves the quality and pertinence of the played multimedia.

### CROSS-REFERENCE TO RELATED APPLICATION

This application claims the priority of Chinese Patent Application No. 20171119577.4, entitled “Method and Apparatus for Playing Multimedia,” filed on Nov. 14, 2017, the content of which is incorporated herein by reference in its entirety.

### TECHNICAL FIELD

Embodiments of the present disclosure relate to the field of computer technologies, generally to the field of computer network technologies, and in particular to a method and apparatus for playing multimedia.

### BACKGROUND

With the coming of the network age, increasingly more users tend to accept intelligent services. Take the audio-visual service as an example, one expects that smart terminals are capable to comprehend user's voice inputs and provide the user with some personalized audio-visual services based on the interpretation of the user's voice.

At present, in an audio-visual voice interaction scenario involving a smart terminal, the terminal is capable of satisfying a real-time retrieval and playback in response to a voice input of the user. Responding to the user's ad hoc needs, the smart terminal will interrupt the current song playing state, and then change the current playing multimedia content based on the interpretation of the user's voice.

### SUMMARY

An object of the embodiments of the present disclosure is to provide a method and an apparatus for playing multimedia.

In the first aspect, embodiments of the present disclosure provide a method for playing multimedia. The method comprises: receiving a voice play request inputted by a user; extracting a scheduled play timing and a play parameter from the voice play request; generating a multimedia list based on the play parameter; and playing multimedia in the multimedia list, in response to a current timing meeting the scheduled play timing.

In some embodiments, the scheduled play timing comprises one or more of: a sorting position, a play time and a play scene of the multimedia.

In some embodiments, the play parameter comprises one or more of following parameters of the multimedia: a name, a leading creative staff, a thematic multimedia list, a list of interested multimedia, a language, a style, a scene, an emotion, and a theme.

In some embodiments, the method further comprises: feeding back response information of the voice play request by voice to the user.

In some embodiments, generating a to-be-played song playlist based on the play parameter comprises: generating the to-be-played song playlist based on the play parameter and one or more of: time—contemporary popularity of the multimedia, a portrait of the user, and feedback data of a preference of the user.

In some embodiments, the feeding back response information of the voice play request by voice to the user comprises one or more of: feeding back received instruction information by voice, in response to generating the multimedia list; feeding back finding no relevant songs by voice to the user, in response to any one of: no play parameter being extracted from the play voice request; and a to-be-played song list not being generated based on the play parameters; and feeding back the multimedia requested by the user having no copyright by voice, in response to a multimedia library not having a multimedia version meeting the play parameter.

In some embodiments, the receiving a voice play request inputted by a user comprises: receiving a wake-up instruction inputted by the user; and feeding back response information by voice and receiving the voice play request inputted by the user.

In the second aspect, the embodiments of the present disclosure provide an apparatus for playing multimedia. The apparatus comprises: a receiving unit for receiving a voice play request inputted by a user; an extracting unit for extracting a scheduled play timing and a play parameter from the voice play request; a generating unit for generating a multimedia list based on the play parameter; and a playing unit for playing multimedia in the multimedia list, in response to a current timing meeting the scheduled play timing.

In some embodiments, the scheduled play timing extracted by the extracting unit comprises one or more of: a sorting position, a play time and a play scene of the multimedia.

In some embodiments, the play parameter extracted by the extracting unit comprises one or more of following parameters of the multimedia: a name, a leading creative staff, a thematic multimedia list, a list of interested multimedia, a language, a style, a scene, an emotion, and a theme.

In some embodiments, the apparatus further comprises a feedback unit for feeding back response information of the voice play request by voice to the user.

In some embodiments, the generating unit is further configured for generating a to-be-played song playlist based on the play parameter and one or more of: time—contemporary popularity of the multimedia, a portrait of the user, and feedback data of a preference of the user.

In some embodiments, the feedback unit is further configured for one or more of: feeding back received instruction information by voice, in response to generating the multimedia list; feeding back finding no relevant songs by voice to the user, in response to any one of: no play parameter being extracted from the play voice request; and a to-be-played song list not being generated based on the play parameters; and feeding back the multimedia requested by the user having no copyright by voice, in response to a multimedia library not having a multimedia version meeting the play parameter.

In some embodiments, the receiving unit comprises: a wake-up subunit for receiving a wake-up instruction inputted by the user; a feedback subunit for feeding back response information by voice; and a receiving subunit for receiving a voice play request inputted by the user.

In the third aspect, the embodiments of the present disclosure provide an apparatus comprising one or more processors; a storage device for storing one or more programs; wherein the one or more processors implements the method for playing multimedia according to any of the foregoing, when the one or more programs are executed by the one or more processors.

In the fourth aspect, the embodiments of the present disclosure provide a computer-readable storage medium having stored thereon a computer program which, when executed by a processor, implements the method for playing multimedia according to any of the foregoing.

The embodiments of the present disclosure provide a method and an apparatus for playing multimedia. Firstly, a voice play request inputted by a user is received; afterwards, a scheduled play timing and a play parameter are extracted from the voice play request; afterwards, a multimedia list is generated based on the play parameters; and the multimedia in the multimedia list is played in response to a current timing meeting the scheduled play timing. During this process, the multimedia in the multimedia list may be played at the scheduled play timing based on the play request made by the user by voice, so as to improve the accuracy and pertinence of the played multimedia.

### BRIEF DESCRIPTION OF THE DRAWINGS

Additional features, objects and advantages of the embodiments of the present disclosure will become more apparent by reading the detailed description of non-limiting embodiments with reference to the following drawings:

FIG. 1 illustrates an exemplary system architecture diagram for implementing embodiments of a method or an apparatus of testing service logic of the present disclosure;

FIG. 2 is a schematic flowchart of an embodiment of a method for playing multimedia in accordance with the present disclosure;

FIG. 3 is a schematic flowchart of an disclosure scenario of a method for playing multimedia in accordance with the present disclosure;

FIG. 4 is an exemplary structural diagram of an embodiment of a method for playing multimedia in accordance with the present disclosure; and

FIG. 5 is a structural diagram of a computer system suitable for implementing a terminal device or a server of the present disclosure.

### DETAILED DESCRIPTION OF EMBODIMENTS

The present application will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the embodiments in the present application and the features in the embodiments may be combined with each other on a non-conflict basis. The present application will be described below in detail with reference to the accompanying drawings and in combination with the embodiments.

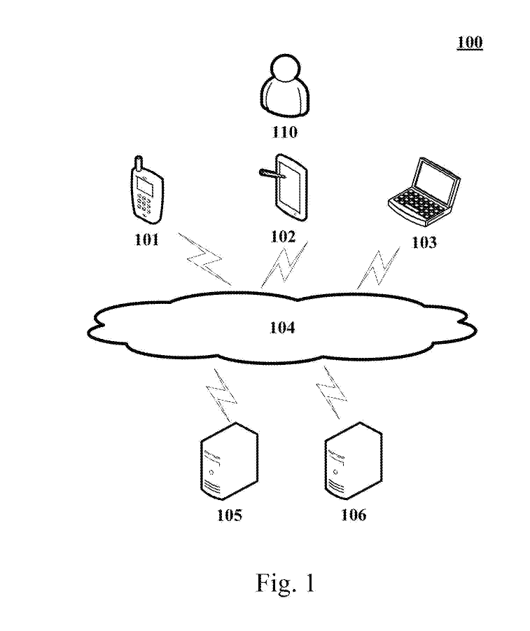

FIG. 1 shows an exemplary architecture of a system 100 which may be used by a method for playing multimedia or an apparatus for playing multimedia according to the embodiments of the present application.

As shown in FIG. 1, the system architecture 100 may include terminal devices 101, 102 and 103, a network 104 and a server 105. The network 104 serves as a medium providing a communication link between the terminal devices 101, 102 and 103 and the server 105. The network 104 may include various types of connections, such as wired or wireless transmission links, or optical fibers.

The user 110 may use the terminal devices 101, 102 and 103 to interact with the server 105 through the network 104, in order to transmit or receive messages, etc. Various communication client applications, such as search engine applications, shopping applications, instant messaging tools, mailbox clients, social platform software and audio-visual playing application may be installed on the terminal devices 101, 102 and 103.

The terminal devices 101, 102 and 103 may be various electronic devices having displays, including but not limited to, smart speaker, smart phones, wearable devices, tablet computers, e-book readers, MP3 (Moving Picture Experts Group Audio Layer III) players, MP4 (Moving Picture Experts Group Audio Layer IV) players, laptop computers and desktop computers.

The servers 105, 106 may be servers providing various services, for example, a backend server providing support to the terminal devices 101, 102 or 103. The backend server may process the data from the terminal devices through analysis and calculation, and push the analysis and calculation results to the terminal devices.

It should be noted that the method for playing multimedia according to the embodiments of the present disclosure is generally executed by the servers 105, 106 or the terminal devices 101, 102, and 103. Accordingly, an apparatus for playing multimedia is generally installed on the server servers 105, 106 or the terminal devices 101, 102, and 103.

It should be appreciated that the number of the terminal devices, networks and servers is illustrative only. Any number of terminal devices, networks and servers may be possible, depending on the practical needs.

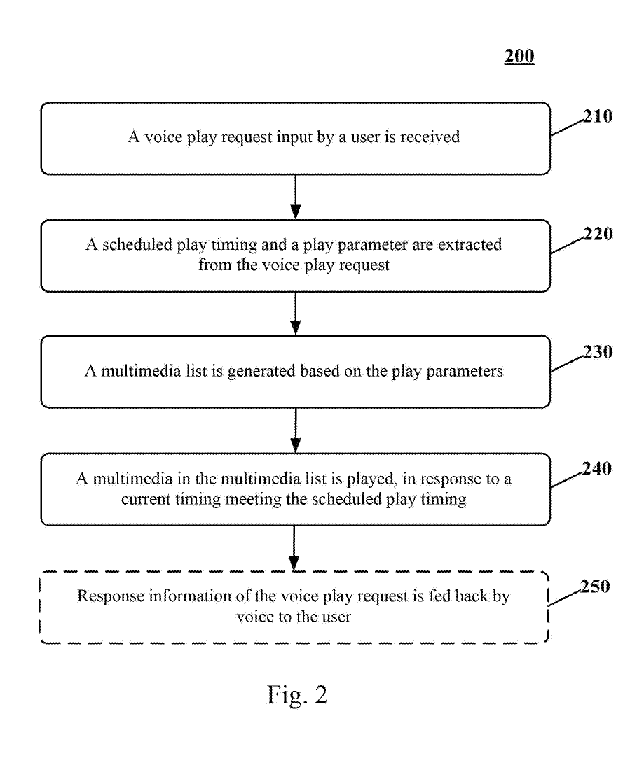

With continuing reference to FIG. 2, FIG. 2 illustrates a schematic flowchart of an embodiment of a method for playing multimedia in accordance with the present disclosure.

As shown in FIG. 2, a method 200 for playing multimedia comprises:

At step 210, a voice play request input by a user is received.

In the embodiment, an electronic device(e.g., a server or a terminal device shown in FIG. 1) that runs a method for playing multimedia may receive a voice play request inputted by a user via a microphone of the terminal device. This voice play request is used to indicate the terminal device to play multimedia, contents of which may be audio contents, video contents, or a combination of audio contents and video contents.

In some alternative implementations of the embodiment, receiving the voice play request inputted by the user may include: receiving a wake-up instruction inputted by the user first, and feeding back response information by voice and receiving the voice play request inputted by the user.

Taking multimedia being a song in the audio contents as an example, the terminal device may receive a voice input “Little A” by a user, wherein “Little A” is a predetermined wake-up instruction. Afterwards, the terminal device feeds back “hey!” by voice to the user. Then, the user inputs a voice play request of “play the next song CCC of BB,” wherein “the next song” is the play timing, BB and CCC are play parameters, where BB is the name of the singer, and CCC is the song title.

At step 220, a scheduled play timing and a play parameter are extracted from the voice play request.

In this embodiment, an electronic device that runs a method for playing multimedia recognizes a voice play request as text, then performs semantic analysis on the text to obtain the semantics included in the voice play request, and may then extract the scheduled play timing hitting a play timing semantic slot, and the play parameters hitting a play parameter semantic slot. The play parameters are the parameters used to filter the multimedia, such as multimedia name or multimedia style.

In some alternative implementations of this embodiment, the scheduled play timing may comprise one or more of: a sorting position, a play time and a play scene of the multimedia.

In this implementation, the sorting position of the multimedia refers to the position of the multimedia in the current playlist, such as, “the next song,” “the 20th song,”. The play time refers to the time of the multimedia playing, such as, “eight o'clock in the morning,” “ten o'clock in the evening,” and “one o'clock at noon each day,””. The play scene refers to scenes where multimedia needs to be played, such as a speed of a vehicle, location-based services, congestion status, mileage status, weather, current news, emotions and crowds, in a specific example, the play scene maybe “when found that I am sleepy,” “when in a traffic jam,” or “when it rains,” and the like.

The sorting position and the play time of the multimedia may specifically indicate the scheduled play timing. The play scene need to be inputted by the user by voice,for example, the user says “Little A (the name of the terminal device), the traffic jam is annoying,” or determined by the terminal device based on the data collected by the device, for example, whether the user is in a drowsy state is determined based on an image, a sound,a pulse or the like collected by the terminal device, whether there is a traffic jam at present is determined based on the location information of the terminal device or the location-based service provided by the automobile manufacturer of the integrated terminal device, and whether it is raining is determined based on the weather forecast disclosed by the Internet and the current location information of the terminal device.

In some alternative implementations of this embodiment, the play parameter may comprise one or more of following parameters of the multimedia: a name, a leading author, a thematic multimedia list, a list of interested multimedia, a language, a style, a scene, an emotion, and a theme.

In this implementation manner, the play parameter may comprise a name of the multimedia, a leading creative staff, a thematic multimedia list, a list of interested multimedia, a language, a style, a scene, an emotion, and a theme, and the like.

In the following, as an example, the multimedia is a song in an audio. The name of the multimedia in the play parameter may be a song title. The leading author may be a singer, a songwriter or a composer. The thematic multimedia list may be an album. The list of interested multimedia may be a song-list. The language may be Chinese, Cantonese, English, Japanese, Korean, German, French, or other languages. The style maybe popular, rock, folk, electronic, dance music, rap, light music, jazz, country, black music, classic, national, British, metal, punk, blues, reggae, Latin, alternative, new age, classical, post rock, new jazz and the like. The scene may be early morning, night, study, work, lunch break, afternoon tea, subway, driving, sport, travel, walking, bar, and the like. The emotion may be reminiscence, freshness, romance, sexy, sadness, healing, relaxing, loneliness, touching, excitement, happiness, quietness, missing, and the like. The theme may be original soundtrack, cartoon, campus, game, 1970s, 1980s, 1990s, network song, KTV, classic, imitation, guitar, piano, instrumental music, child, list, 2000s and so on.

At step 230, a multimedia list is generated based on the play parameters.

In the embodiment, the multimedia matching the play parameters may be extracted from the multimedia library or the network data based on the play parameters extracted from the voice play request. For example, if the play parameters extracted from the voice play request are “English,” “Country” and “Songs,” songs matching both “English” and “Country” may be extracted from the music library to generate a song playlist.

In some alternative implementations of this embodiment, generating a list of multimedia based on the play parameter comprises: generating a to-be-played song playlist based on the play parameter and one or more of: time—contemporary popularity of the multimedia, a user portrait, and user preference feedback data.

In this implementation, both the user portrait and the user preference feedback data may be obtained based on the big data or the historical interaction data of the user. At this point, a personalized multimedia list that better matches the user preference may be filtered out by referring to the user portrait and preference feedback data input by the user based on the play parameters, so as to improve the relevance of the multimedia in the multimedia list.

At step 240, multimedia in the multimedia list is played, in response to a current timing meeting the scheduled play timing.

In this embodiment, the multimedia in the multimedia list may be played via a speaker of the terminal device in response to the terminal device monitoring that the current condition meets the scheduled play timing. For example, if the scheduled play timing extracted from the voice play request is “eight o'clock in the morning, ” the multimedia in the multimedia list may be played when the terminal device detects that the current time is eight o'clock in the morning.

When playing a multimedia list, a history playlist before the played multimedia list may be reserved so as to still be capable of returning to the content in the history playlist, when the user inputs the play request of “previous song.”

Optionally, at step 250, the method for playing multimedia described above may further include: feeding back response information of the voice play request to the user by voice.

In this implementation, a voice may be used to response to the play request to the user, so that the user can receive the feedback of the terminal device in a timely and convenient manner. For example, after receiving a voice play request by a user and generating a multimedia list, “alright” may be fed back to the user. Otherwise, if extracting the play parameters fails, “sorry, no relevant songs are found” is fed back to the user.

In some alternative implementations of this embodiment, the feeding back response information of the voice play request by voice to the user comprises: feeding back received instruction information by voice, in response to generating the multimedia list; feeding back finding no relevant songs by voice to the user, in response to any one of: no play parameter being extracted from the play voice request;

and a to-be-played song list not being generated based on the play parameters; and feeding back the multimedia requested by the user having no copyright by voice, in response to a multimedia library not having a multimedia version meeting the play parameter.

In this implementation, response information (such as “alright,” “no problem,” “OK”) of the voice play request may be fed back by voice to the user, in response to generating the multimedia list. Finding no relevant songs is fed back by voice to the user, in response to no play parameter being extracted from the play voice request; or to a to-be-played song list not being generated based on the play parameters. For example, if the play parameter in the voice play request for the user is “Eight Miles Incense of XX,” no multimedia in the multimedia library would satisfy the expression, as a result, “no relevant songs are found” is fed back. The multimedia requested by the user having no copyright is fed back by voice, in response to a multimedia library not having a multimedia version meeting the play parameter. For example, “the related song has no copyright” is fed back to the user.

The above-described embodiments of the present disclosure provide a method for playing multimedia, the method extracts a scheduled play timing and a play parameter based on the voice play request by the user, and play multimedia that meet a play parameter on the scheduled play timing, so that the played multimedia better meets the needs of the user, so as to enhance the accuracy and pertinence of the multimedia played to the user.

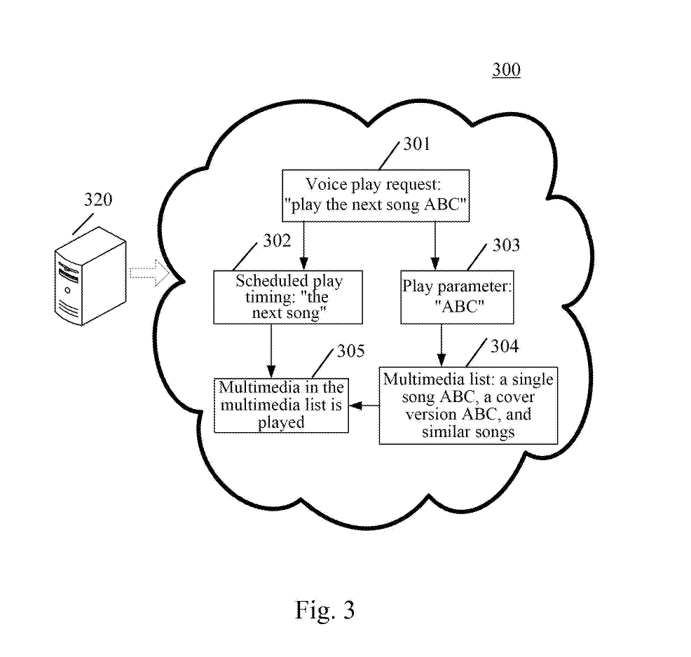

An exemplary application scenario of a method for playing multimedia of present disclosure is described below with reference to FIG. 3.

As shown in FIG. 3, FIG. 3 illustrates a schematic flowchart of an application scenario of a method for playing multimedia in accordance with the present disclosure.

As shown in FIG. 3, the method 300 for playing multimedia is operated in the smart speaker 320, and the method may include:

A voice play request 301 inputted by a user is first received.

A scheduled play timing 302 “next song” and a play parameter 303 “ABC” are then extracted from the voice play request 301: “play the next song ABC.”

A multimedia list 304 is then generated based on the play parameter 303 “ABC”: which may include a single song ABC, a cover version ABC, and similar songs.

Finally, a multimedia 305 in the multimedia list 304 is played, in response to a current timing being the current played song, meeting the scheduled play timing 302 “Next.”

It should be understood that the method for playing multimedia shown in FIG. 3 is merely an exemplary embodiment of the method for playing multimedia, and is not intended to limit the embodiments of the present disclosure. For example, after playing multimedia in the multimedia list 305 in response to a current timing meeting the scheduled play timing 302, response information of the voice play request may be fed back by voice to the user. For another example, generating a to-be-played song playlist based on the play parameter may comprise: generating the to-be-played song playlist based on the play parameter and one or more of: time—contemporary popularity of the multimedia, a portrait of the user, and feedback data of a preference of the user.

The method for playing multimedia provided in the above-described disclosure scenario of embodiments of the present disclosure can improve the accuracy and pertinence of the played multimedia.

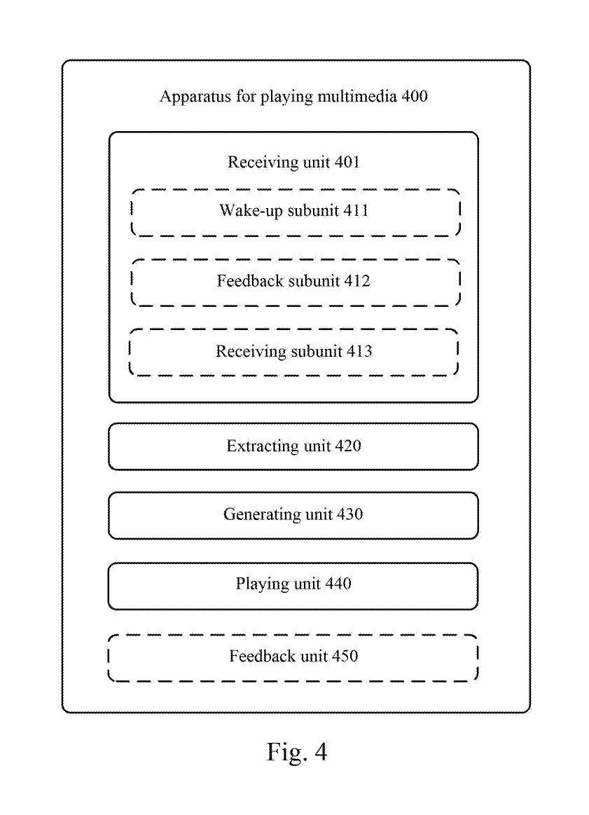

Further referring to FIG. 4, as an implementation of the above method, the present disclosure provides an embodiment of an apparatus for playing multimedia, and the embodiment of the apparatus for playing multimedia corresponds to the embodiment of the method for playing multimedia shown in FIG. 1 to FIG. 3. Therefore, the operations and features described above with respect to the method for playing multimedia in FIG. 1 to FIG. 3 are also applicable to an apparatus for playing multimedia 400 and the units contained therein, and will not be reiterated here.

As shown in FIG. 4, the apparatus for playing multimedia 400 includes: a receiving unit 410 for receiving a voice play request inputted by a user; an extracting unit 420 for extracting a scheduled play timing and a play parameter from the voice play request; a generating unit 430 for generating a multimedia list based on the play parameter; and a playing unit 440 for playing multimedia in the multimedia list, in response to a current timing meeting the scheduled play timing.

In some embodiments, the scheduled play timing extracted by the extracting unit 420 include one or more of: a sorting position, a play time and a play scene of the multimedia.

In some embodiments, the play parameter extracted by the extracting unit 420 comprises one or more of following parameters of the multimedia: a name, a leading author, a thematic multimedia list, a list of interested multimedia, a language, a style, a scene, an emotion, and a theme.

In some embodiments, the apparatus 400 further comprises: a feedback unit 450 for feeding back response information of the voice play request by voice to the user.

In some embodiments, the generating unit 430 is further configured for: generating a to-be-played song playlist based on the play parameter and one or more of: time—contemporary popularity of the multimedia, a user portrait, and user preference feedback data.

In some embodiments, the feedback unit 450 is further configured for one or more of: feeding back received instruction information by voice, in response to generating the multimedia list; feeding back finding no relevant songs by voice to the user, in response to any one of: no play parameter being extracted from the play voice request; and a to-be-played song list not being generated based on the play parameters; and feeding back the multimedia requested by the user having no copyright by voice, in response to a multimedia library not having a multimedia version meeting the play parameter.

In some embodiments, the receiving unit 410 comprises: a wake-up subunit 411 for receiving a wake-up instruction inputted by the user; a feedback subunit 412 for feeding back response information by voice; and a receiving subunit 413 for receiving a voice play request inputted by the user.

The present disclosure also provides an apparatus comprising: one or more processors; a storage device for storing one or more programs; wherein the one or more processors implements the method for playing multimedia according to any of the foregoing, when the one or more programs are executed by the one or more processors.

The present disclosure further provides an embodiment of a computer-readable storage medium having stored thereon a computer program which, when executed by a processor, implements the method for playing multimedia according to any of the foregoing.

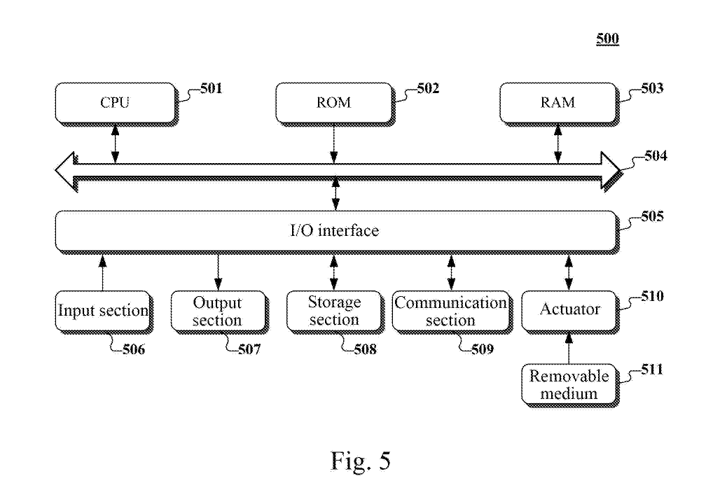

Below refer to FIG. 5, which illustrates a structural diagram of a computer system 500 suitable for implementing a terminal device or a server of an embodiment of the present disclosure. The terminal device shown in FIG. 5 is merely an example, and should not impose any limitation on the function and the scope of use of the embodiments of the present disclosure.

As shown in FIG. 5, the computer system 500 includes a central processing unit (CPU) 501, which may execute various appropriate actions and processes in accordance with a program stored in a read-only memory (ROM) 502 or a program loaded into a random access memory (RAM) 503 from a storage portion 508. The RAM 503 also stores various programs and data required by operations of the system 500. The CPU 501, the ROM 502 and the RAM 503 are connected to each other through a bus 504. An input/output (I/O) interface 505 is also connected to the bus 504.

The following components are connected to the I/O interface 505: an input portion 506 including a keyboard, a mouse etc.; an output portion 507 comprising a cathode ray tube (CRT), a liquid crystal display device (LCD), a speaker etc.; a storage portion 508 including a hard disk and the like; and a communication portion 509 comprising a network interface card, such as a LAN card and a modem. The communication portion 509 performs communication processes via a network, such as the Internet. A driver 510 is also connected to the I/O interface 505 as required. A removable medium 511, such as a magnetic disk, an optical disk, a magneto-optical disk, and a semiconductor memory, may be installed on the driver 510, to facilitate the retrieval of a computer program from the removable medium 511, and the installation thereof on the storage portion 508 as needed.

In particular, according to embodiments of the present disclosure, the process described above with reference to the flow chart may be implemented in a computer software program. For example, an embodiment of the present disclosure includes a computer program product, which comprises a computer program that is tangibly embedded in a machine-readable medium. The computer program comprises program codes for executing the method as illustrated in the flow chart. In such an embodiment, the computer program may be downloaded and installed from a network via the communication portion 509, and/or may be installed from the removable media 511. The computer program, when executed by the central processing unit (CPU) 501, implements the above mentioned functionalities as defined by the methods of the present disclosure.

It should be noted that the computer readable medium in the present disclosure maybe computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In the present disclosure, the computer readable storage medium may be any physical medium containing or storing programs which can be used by a command execution system, apparatus or element or incorporated thereto. In the present disclosure, the computer readable signal medium may include data signal in the base band or propagating as parts of a carrier, in which computer readable program codes are carried. The propagating signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The units or modules involved in the embodiments of the present disclosure may be implemented by means of software or hardware. The described units or modules may also be provided in a processor, for example, described as: a processor, comprising a receiving unit, an extracting unit, a generating unit and a paying unit, where the names of these units or modules do not in some cases constitute a limitation to such units or modules themselves. For example, the receiving unit may also be described as “a unit for receiving a voice play request inputted by a user.”

In another aspect, the present disclosure further provides a non-volatile computer-readable storage medium. The non-volatile computer-readable storage medium may be the non-volatile computer storage medium included in the apparatus in the above described embodiments, or a stand-alone non-volatile computer-readable storage medium not assembled into the apparatus. The non-volatile computer-readable storage medium stores one or more programs. The one or more programs, when executed by a device, cause the device to: receive a voice play request inputted by a user; extract a scheduled play timing and a play parameter from the voice play request; generate a multimedia list based on the play parameter; and play multimedia in the multimedia list, in response to a current timing meeting the scheduled play timing.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present disclosure are examples.

What is claimed is:

1. A method for playing multimedia, the method comprising:
receiving a voice play request inputted by a user;
extracting a scheduled play timing and a play parameter from the voice play request;
generating a multimedia list based on the play parameter; and
playing multimedia in the multimedia list, in response to a current timing meeting the scheduled play timing.

2. The method according to claim 1, wherein the scheduled play timing comprises one or more of: a sorting position, a play time and a play scene of the multimedia.

3. The method according to claim 1, wherein the play parameter comprises one or more of following parameters of the multimedia: a name, a leading author, a thematic multimedia list, a list of interested multimedia, a language, a style, a scene, an emotion, and a theme.

4. The method according to claim 1, the method further comprising:
feeding back response information of the voice play request by voice to the user.

5. The method according to claim 1, wherein generating a multimedia playlist based on the play parameter comprises:
generating the multimedia playlist based on the play parameter and one or more of: time—contemporary popularity of the multimedia, a portrait of the user, and feedback data of a preference of the user.

6. The method according to claim 4, wherein the feeding back response information of the voice play request by voice to the user comprises one or more of:
feeding back received instruction information by voice, in response to generating the multimedia list;
feeding back finding no relevant songs by voice to the user, in response to any one of: no play parameter being extracted from the play voice request; and a to-be-played song list not being generated based on the play parameters; and
feeding back the multimedia requested by the user having no copyright by voice, in response to a multimedia library not having a multimedia version meeting the play parameter.

7. The method according to claim 1, wherein the receiving a voice play request inputted by a user comprises:
receiving a wake-up instruction inputted by the user; and
feeding back response information by voice and receiving the voice play request inputted by the user.

8. An apparatus for playing multimedia, the apparatus comprising:
at least one processor; and
a memory storing instructions, the instructions when executed by the at least one processor, cause the at least one processor to perform operations, the operations comprising:
receiving a voice play request inputted by a user;
extracting a scheduled play timing and a play parameter from the voice play request;
generating a multimedia list based on the play parameter; and
playing multimedia in the multimedia list, in response to a current timing meeting the scheduled play timing.

9. The apparatus according to claim 8, wherein the scheduled play timing comprises one or more of: a sorting position, a play time and a play scene of the multimedia.

10. The apparatus according to claim 8, wherein the play parameter comprises one or more of following parameters of the multimedia: a name, a leading author, a thematic multimedia list, a list of interested multimedia, a language, a style, a scene, an emotion, and a theme.

11. The apparatus according to claim 8, wherein the operations further comprise:
feeding back response information of the voice play request by voice to the user.

12. The apparatus according to claim 8, wherein the generating unit being further configured for:
generating a multimedia playlist based on the play parameter and one or more of: time—contemporary popularity of the multimedia, a portrait of the user, and feedback data of a preference of the user.

13. The apparatus according to claim 12, wherein the feeding back response information of the voice play request by voice to the user comprise one or more of:
feeding back received instruction information by voice, in response to generating the multimedia list;
feeding back finding no relevant songs by voice to the user, in response to any one of: no play parameter being extracted from the play voice request; and a to-be-played song list not being generated based on the play parameters; and
feeding back the multimedia requested by the user having no copyright by voice, in response to a multimedia library not having a multimedia version meeting the play parameter.

14. The apparatus according to claim 8, wherein the receiving a voice play request inputted by a user comprises:
receiving a wake-up instruction inputted by the user;
feeding back response information by voice; and
receiving a voice play request inputted by the user.

15. Anon-transitory computer storage medium storing a computer program, the computer program when executed by one or more processors, causes the one or more processors to perform operations, the operations comprising:
receiving a voice play request inputted by a user;
extracting a scheduled play timing and a play parameter from the voice play request;
generating a multimedia list based on the play parameter; and
playing multimedia in the multimedia list, in response to a current timing meeting the scheduled play timing.
